(19) United States
(12) Patent Application Publication
(10) Pub. No.: US 2024/0152728 A1
(43) Pub. Date: May 9, 2024

(54) METHOD AND APPARATUS FOR MANAGING MODEL INFORMATION OF ARTIFICIAL NEURAL NETWORKS FOR WIRELESS COMMUNICATION IN MOBILE COMMUNICATION SYSTEM

(71) Applicant: Electronics and Telecommunications Research Institute, Daejeon (KR)

(72) Inventors: Han Jun PARK, Daejeon (KR); Yong Jin KWON, Daejeon (KR); An Seok LEE, Daejeon (KR); Heesoo LEE, Daejeon (KR); Yun Joo KIM, Daejeon (KR); Hyun Seo PARK, Daejeon (KR); Jung Bo SON, Daejeon (KR); Yu Ro LEE, Daejeon (KR)

(73) Assignee: Electronics and Telecommunications Research Institute, Daejeon (KR)

(21) Appl. No.: 18/503,611

(22) Filed: Nov. 7, 2023

(30) Foreign Application Priority Data
Nov. 7, 2022 (KR) 10-2022-0147077
Nov. 10, 2022 (KR) 10-2022-0149456
May 30, 2023 (KR) 10-2023-0069353

(51) Int. Cl. G06N 3/04; G06N 5/04

(52) U.S. Cl. CPC G06N 3/04; G06N 5/04

(57) ABSTRACT

A method of a communication node may comprise: transmitting required network configurations for applying each of artificial neural network models to a network node; and transmitting a status report of the first model including a model identifier field and a model information field for each of the artificial neural network models to the network node to activate at least one artificial neural network model among the artificial neural network models, wherein each of the required network configurations includes a configuration identifier and network configuration information.

### CROSS-REFERENCE TO RELATED APPLICATIONS

This application claims priority to Korean Patent Applications No. 10-2022-0147077, filed on Nov. 7, 2022, No. 10-2022-0149456, filed on Nov. 10, 2022, and No. 10-2023-0069353, filed on May 30, 2023, with the Korean Intellectual Property Office (KIPO), the entire contents of which are hereby incorporated by reference.

### BACKGROUND

### 1. Technical Field

Exemplary embodiments of the present disclosure relate to a technique for managing information in a mobile communication system, and more specifically, to a technique for managing information on artificial neural network models for wireless communication in a mobile communication system.

### 2. Related Art

The 3rd Generation Partnership Project (3GPP), an international standardization organization, has selected the application of artificial intelligence (AI) and machine learning (ML) for New Radio (NR) air interfaces as a study item (SI) in Release 18. The purpose of the SI is to establish use cases for AUML utilization in NR radio interfaces and to identify a performance gain for each specific use case. Specifically, representative use cases include the enhancement of Channel State Information (CSI) feedback, beam management, and improved positioning accuracy.

### SUMMARY

Exemplary embodiments of the present disclosure are directed to providing a method and an apparatus for managing information on artificial neural network models for wireless communication in a mobile communication system.

According to a first exemplary embodiment of the present disclosure, a method of a communication node may comprise: transmitting required network configurations for applying each of artificial neural network models to a network node; and transmitting a status report of the first model including a model identifier field and a model information field for each of the artificial neural network models to the network node to activate at least one artificial neural network model among the artificial neural network models, wherein each of the required network configurations includes a configuration identifier and network configuration information.

The network configuration information may include one or more Radio Resource Configuration (RRC) information elements (IEs) corresponding to a required network configuration corresponding to each of the artificial neural network models.

The model information field may include at least one of required network configuration information for an inference task corresponding to each of the artificial neural network models, auxiliary network configuration information for an inference task corresponding to each of the artificial neural network models, model performance indicator for each of the artificial neural network models, preference for each of the artificial neural network models, or preference priority information for each of the artificial neural network models.

The status report of the first model may include only a model status report corresponding to a currently supportable artificial neural network model.

The method may further comprise: transmitting a status report of the second model to the network node, wherein the second model state report is transmitted to the network node, when at least one occurs among a case when model status information of the communication node is changed, a case when the network node indicates the communication node to transmit the status report of the second model, a case when a retransmission prohibit timer for the status report of the first model expires and there is an artificial neural network model currently supported by the communication node, a case when a periodic transmission timer for the status report of the first model expires and there is an artificial neural network model currently supported by the communication node, or a case when a handover procedure occurs.

The method may further comprise: receiving, from the network node, indication information on activation or deactivation of an artificial neural network model corresponding to an artificial neural network model not included in the status report of the first model; and ignoring the activation or deactivation of the artificial neural network model according to the indication information.

The method may further comprise: receiving, from the network node, an activation indication on one or more artificial neural network models in response to the status report of the first model; activating the one or more artificial neural network models based on the activation indication; when an artificial neural network model activated in the communication node is deactivated, generating a status report of the second model including deactivation information of the deactivated artificial neural network model; and transmitting the status report of the second model to the network node.

When there is a first artificial neural network model on which the communication node and the network node need to jointly perform an inference task among the artificial neural network models, the model information field may include at least one of whether or not a network node-sided artificial neural network model exists in the network node, an identifier of the network node-sided artificial neural network model of the network node, input and output of the network node-sided artificial neural network model of the network node, execution environment information of the network node-sided artificial neural network model of the network node, or an inference latency required for an inference operation of the network node-sided artificial neural network model of the network node.

The method may further comprise: receiving, from the network node and in advance, information of a first artificial neural network model on which the communication node and the network node need to jointly perform an inference task.

The network node may be one of a base station connected to the communication node, a server that manages the artificial neural network models, or a cloud that manages the artificial neural network models.

According to a second exemplary embodiment of the present disclosure, a method of a network node may comprise: receiving required network configurations for applying each of artificial neural network models from a communication node; receiving at least one status report of the first model including a model identifier field and a model information field for each of the artificial neural network models; determining whether to allow each of the artificial neural network models based on the received status report of the first model and a load of the network node; and transmitting information indicating whether or not to allow each of the artificial neural network models to the communication node, wherein each of the required network configurations includes a configuration identifier and network configuration information.

The network configuration information may include one or more Radio Resource Configuration (RRC) information elements (IEs) corresponding to a required network configuration corresponding to each of the artificial neural network models.

The model information field may include at least one of required network configuration information for an inference task corresponding to each of the artificial neural network models, auxiliary network configuration information for an inference task corresponding to each of the artificial neural network models, model performance indicator for each of the artificial neural network models, preference for each of the artificial neural network models, or preference priority information for each of the artificial neural network models.

The method may further comprise: when deactivation of an activated artificial neural network model is required based on the model performance indicator of each of the artificial neural network models, transmitting information indicating deactivation of the activated artificial neural network model to the communication node.

The method may further comprise: receiving a status report of the second model from the communication node; and ignoring the received status report of the second model, when the status report of the second model indicates deactivation of an activated artificial neural network model.

The method may further comprise: receiving a status report of the second model from the communication node; and starting a procedure for deactivating an activated artificial neural network model based on the received status report of the second model, when the status report of the second model indicates deactivation of the activated artificial neural network model.

The method may further comprise: providing, to the communication node, information of a first artificial neural network model on which the communication node and the network node need to jointly perform an inference task.

According to exemplary embodiments of the present disclosure, a terminal and a network node (e.g., base station) have advantages of being able to support terminal operations with a small signal transmission load. Therefore, when a terminal actively changes an artificial neural network model, such a situation can be quickly reported to the network node and shared with the network node. In particular, depending on a battery consumption and/or heat status of the terminal, the number of supportable artificial neural network models can be reduced or the existing model can be replaced with a more simplified artificial neural network model.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is an exemplary diagram illustrating a case where a terminal reports two-stage artificial neural network model information according to the first exemplary embodiment of the present disclosure.

FIG. 4 is a conceptual diagram illustrating an operation of reporting artificial neural network model statuses so that only models that the terminal can currently support are included in the reporting according to the fifth exemplary embodiment of the present disclosure.

FIG. 5 is a conceptual diagram for describing an operation according to an artificial neural network model status reporting trigger of a terminal according to the sixth exemplary embodiment of the present disclosure.

FIG. 6 is a conceptual diagram illustrating an operation based on a model status reporting process for an activated artificial neural network model according to the eighth exemplary embodiment of the present disclosure.

FIG. 7 is a conceptual diagram for describing operations according to model status reporting and activation for a two-sided AI/ML model according to the tenth exemplary embodiment of the present disclosure.

FIG. 8 is a conceptual diagram for describing operations according to model status reporting and activation for a two-sided AI/ML model according to the tenth exemplary embodiment of the present disclosure.

FIG. 9 is a conceptual diagram for describing artificial neural network model information registration and calling operations according to the eleventh exemplary embodiment of the present disclosure.

### DETAILED DESCRIPTION OF THE EMBODIMENTS

While the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSDPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and redundant descriptions for the same elements are omitted.

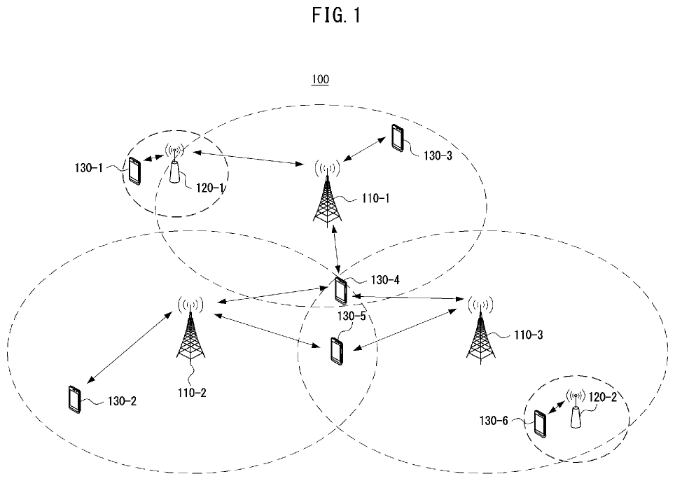

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 gigahertz (GHz) or below, and the 5G communication may be performed in a frequency band of 6 GHz or above as well as the frequency band of 6 GHz or below.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

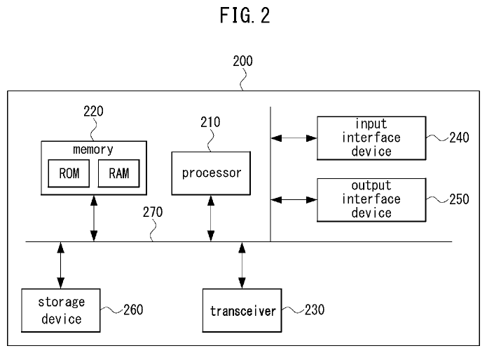

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g., a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g., a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for managing artificial neural network models in a communication system will be described. Even when a method (e.g., transmission or reception of a signal) performed at a first communication node among communication nodes is described, the corresponding second communication node may perform a method (e.g., reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g., remote radio transmission/reception function, baseband processing function, and the like) of a communication protocol. Alternatively, the remote radio transmission/reception function among all the functions of the communication protocol may be performed by a transmission reception point (TRP) (e.g., flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

Meanwhile, the 3rd Generation Partnership Project (3GPP), an international standardization organization, has selected the application of artificial intelligence (AI) and machine learning (ML) for New Radio (NR) air interfaces as a study item in Release 18. The purpose of this SI is to establish use cases for AI/ML utilization in NR radio interfaces and to identify a performance gain for each specific use case. Specifically, representative use cases include the enhancement of Channel State Information (CSI) feedback, beam management, and improved positioning accuracy.

The CSI feedback refers to a process in which a terminal reports CSI in order to support a base station to apply a transmission technique or precoding such as MIMO in the mobile communication system. The 5G NR technical specifications defined by the 3GPP support feedback information such as a channel quality indicator (CQI), precoding matrix indicator (PMI), rank indicator (RI), and the like in connection with to the CSI feedback scheme. In the NR system, in order to effectively support a transmission technique such as multi-user MIMO (MU-MIMO), discussion on improving the CSI feedback techniques continues. Specifically, the 3GPP NR system supports two types of codebooks to convey PMI information, which are respectively named a Type 1 codebook and a Type codebook. The Type 1 codebook has a structure in which a beam group is represented by oversampled discrete Fourier transform (DFT) matrixes, and one beam selected from the beam group is transmitted. On the other hand, the Type 2 codebook has a structure in which a plurality of beams are selected and information is transmitted in form of a linear combination of the selected beams. The Type 2 codebook has been evaluated as having a structure more suitable for supporting transmission techniques such as MU-MIMO compared to the Type 1 codebook, but has a disadvantage in that a CSI feedback load greatly increases according to its complex codebook structure. In relation to the above-described problem, a study on a method of obtaining a compressed latent expression for a MIMO channel using an auto-encoder, which is one of recent deep learning techniques, is being conducted.

The beam management refers to a process of allocating transmission beam and/or reception beam resources in a mobile communication system when a base station and a terminal can apply analog beams using spatial filters to transmission and reception. In the 5G NR technical specifications defined by the 3GPP, reference signals such as synchronization signal block (SSB) and/or CSI-reference signal (CSI-RS) may be transmitted in a plurality of analog beam directions, such that the base station and/or terminal can search for an optimal beam. However, the scheme in which the terminal searches for all of a plurality of analog beam directions and reports the optimal beam direction to the base station each time may have limitations in that a time delay and a signal transmission load may be caused. In relation to the above-described problem, researches are currently being conducted to predict information for a next beam by utilizing reinforcement learning, one of techniques in the field of AWL, or to infer high-resolution beam information from low-resolution beam information using a supervised learning scheme.

The positioning refers to a technique for measuring a position of a specific terminal in a mobile communication system. The 5G NR technical specifications defined by the 3GPP support a positioning scheme using an observed time difference of arrival (OTDOA) obtained by transmitting a positioning reference signal (PRS) to allow the terminal to report a reference signal time difference (RSTD). Recently, requirements for positioning accuracy are increasing, and researches on improving the accuracy of measurement values for positioning by applying AUML techniques to an RF finger print scheme are being conducted from the perspective described above.

As in the use cases discussed above, when an artificial neural network is introduced for wireless communication between a base station and a terminal in a mobile communication system, life cycle management (LCM) for the artificial neural network may be required. The life cycle management of the artificial neural network may refer to a series of processes for constructing and utilizing the artificial neural network. The 3GPP standardization organization defines, as the LCM processes, data collection, model training, inference operation using model, model deployment, model activation, model deactivation, model selection, model monitoring, model transfer, and the like. For example, each model may have a life cycle such as (data collection→model training→model deployment→model activation→inference operation using the model→model monitoring).

In addition, the 3GPP standardization organization is discussing a model registration process, which is a process in which a base station and a terminal exchange information to recognize each other's artificial neural network models during the LCM process. For example, when the terminal supports one or more artificial neural network models for wireless communication, a specific network resource configuration may be required to utilize each artificial neural network model. When a specific network resource configuration is required, the terminal may report the artificial neural network models it possesses and information on required network resource configurations for each model to the base station so that each artificial neural network model can be utilized. The process of reporting information for each artificial neural network model of the terminal may be an example of the model registration process. In other words, the model registration process may be a process of reporting model-specific information of artificial neural network models that the terminal can support to the base station. The base station may indicate activation/deactivation of a specific model based on the information on artificial neural network models, which is reported by the terminal.

Meanwhile, information related to artificial neural network models may include information on functionality supported by each model, identifier for a model provider (i.e., vendor identification) of each model, scenario/region for application of each model, configuration for application of each model, input of each model, output of each model, and assistance information other than input for the model's inference operation. In a commercial wireless communication system, information related to artificial neural network models that a terminal can support may change dynamically. For example, the terminal cannot support a specific artificial neural network model when the specific artificial neural network model has not been deployed or is being updated, and can support a specific artificial neural network model when it has been deployed and is not being updated. Alternatively, the terminal may reduce the number of models it can support depending on its battery consumption and/or heat condition, or replace the existing model with a more simplified artificial neural network model. Therefore, the terminal needs to quickly report information on artificial neural network models to the base station. In the existing 3GPP organization, a model registration method in which the terminal reports artificial neural network model-related information for each model identifier (i.e., Model ID) is being discussed. However, since the above method involves transmitting a lot of information each time, a load of signal transmission may become high, and thus it may not be a suitable method for the terminal to quickly report model status information.

Therefore, the present disclosure proposes a method that allows a terminal to quickly report information on a plurality of artificial neural network models for wireless communication to a base station while fully delivering information on the plurality of artificial neural network models to the base station in a mobile communication system consisting of the base station and the terminal.

For convenience of description, artificial neural network configuration and learning methods proposed in the present disclosure will be mainly described from a downlink perspective of a wireless mobile communication system consisting of a base station and a terminal. However, the methods proposed in the present disclosure may be extended and applied to any wireless mobile communication system consisting of a transmitter and a receiver.

In addition, for convenience of description, in the present disclosure classifies the types of AWL models as follows depending on location of a network node where an inference task is performed.
One-sided AI/ML Model
AI/ML model by which inference is performed entirely on a device or network
When inference is performed entirely on a terminal, the model is classified as a UE-sided AI/ML model, and when inference is performed on a network, the model is classified as a network-sided AI/ML model.
Two-sided AI/ML Model
Paired AI/ML model(s) by which joint inference is performed.
Joint inference includes AI/ML inference performed jointly across a terminal and a network

For example, a first part of inference may be performed by a terminal and a remaining part thereof may be performed by a base station, or vice versa.

### First Exemplary Embodiment

The first exemplary embodiment of the present disclosure may be applied when the following conditions are satisfied.

Condition 1: An artificial neural network for wireless communication is applied to a mobile communication system consisting of a base station and a terminal.

Condition 2: The terminal may configure and/or utilize one or more artificial neural network model(s).

According to the first exemplary embodiment of the present disclosure, a terminal (or an upper entity/cloud/server that manages artificial neural networks of the terminal) that satisfies Condition 1 and Condition 2 may report information on each of one or more artificial neural network models to the base station in two stages.

When reporting in the first-stage, the terminal may report one or more required network configurations.

When reporting in the second-stage, the terminal may report model-specific status information for the one or more artificial neural network models.

If information on a required network configuration for each artificial neural network model is reported in the second-stage together with the model-specific status information, the report may be done in a form that refers to the required network configuration reported in the first-stage.

However, each of the first-stage report and/or second-stage report of the terminal (or upper entity/cloud/server that manages the artificial neural networks of the terminal) may further include information other than the required network configuration.

As an exemplary embodiment of the present disclosure, it is assumed that the terminal that satisfies Condition 1 requires a specific network configuration to apply artificial neural network model(s). This may be the required network configuration(s) reported in the first-stage described above.

Hereinafter, the required network configuration(s) will be described. The required network configuration(s) may be specific configuration(s) that need to be provided by the network when the terminal applies the artificial neural network model. As a specific example, it is assumed that the terminal supports one or more artificial neural network models for a purpose of CSI prediction for future times (hereinafter referred to as ‘CSI prediction artificial neural network models’). In this case, in order for the terminal to utilize the CSI prediction artificial neural network model, the base station may need to periodically transmit a CSI-reference signal (CSI-RS). Therefore, periodic transmission of CSI-RS may be required as one of the required network configurations for the terminal to use the artificial neural network model.

Meanwhile, in a cell-based mobile communication system, cell performance may be managed by the network or base station. Therefore, if the artificial neural network model of the terminal presupposes a specific configuration of the network or base station, it may be preferable for the base station to make a final decision on whether to allow the artificial neural network model. For instance, it may be assumed that support of a CSI prediction artificial neural network model results in a 5% performance gain, while application of a required network configuration therefore causes a 1% increase in the downlink's reference signal load.

In this case, if there is only one terminal that supports the artificial neural network model within a cell, the performance gain is higher than the system load, so it may be preferable to use the CSI prediction artificial neural network model. On the other hand, if the total number of terminals within the cell is 100 and only one terminal among them supports the artificial neural network model, in other words, if there are 99 terminals that do not support the artificial neural network model, compared to the gain achieved by supporting the artificial neural network model, the performance reduction of other terminals due to the reference signal load may be significant. In this case, it may be preferable for the base station not to use the CSI prediction artificial neural network model.

Therefore, the terminal needs to deliver, to the base station, information on network configurations (e.g., CSI-RS configuration) required for utilizing each artificial neural network model (e.g., CSI prediction artificial neural network model), so that the terminal is supported by utilization of the artificial neural network model.

According to an exemplary embodiment of the present disclosure, the terminal may describe and report the required network configurations for the respective artificial neural network models to the base station at once. However, there may be a case where multiple artificial neural network models exist for the same function. For example, two or more different CSI prediction artificial neural network models may exist depending on a target CSI prediction. When a plurality of artificial neural network models that perform the same function exist, but differ from each other, these different artificial neural network models that perform the same function may have distinct model structures and/or model parameters. However, the required network configurations of the different artificial neural network models that perform the same function may be almost similar. Therefore, if the terminal reports all required network configurations for the respective models to the base station, a large part of the required network configurations may be redundant, resulting in the disadvantage of unnecessarily increasing the signal transmission load.

In order to solve the above-described problem, the present disclosure proposes the two-stage reporting method described above.

When reporting in the first-stage according to the present disclosure, the terminal may report one or more required network configurations. For example, a case where the terminal can use a plurality CSI prediction artificial neural network models may be considered. Then, the terminal may first report to the base station CSI-RS configuration(s) required to utilize the plurality of CSI prediction artificial neural network models. In this case, there may be one or two or more required CSI-RS configurations. Therefore, the terminal may assign different identifiers for the respective required network configurations, and report them to the base station.

When reporting in the second-stage according to the present disclosure, the terminal may report model-specific status information for the one or more artificial neural network models. In this case, when reporting the model-specific status information, the terminal may report it in a form that refers to the required network configuration(s) reported in the first-stage. In other words, when reporting model-specific status information for CSI prediction artificial neural network models, the terminal may report to the base station an identifier corresponding to the required network configuration for each model among the previously reported CSI-RS configurations.

Based on the terminal's second-stage report, the base station may determine whether to change the required network configuration(s). In other words, the base station may predict a network load according to the use of each artificial neural network model based on the report from the terminal, and use it to determine whether to allow the artificial neural network model and/or determine a final required network configuration.

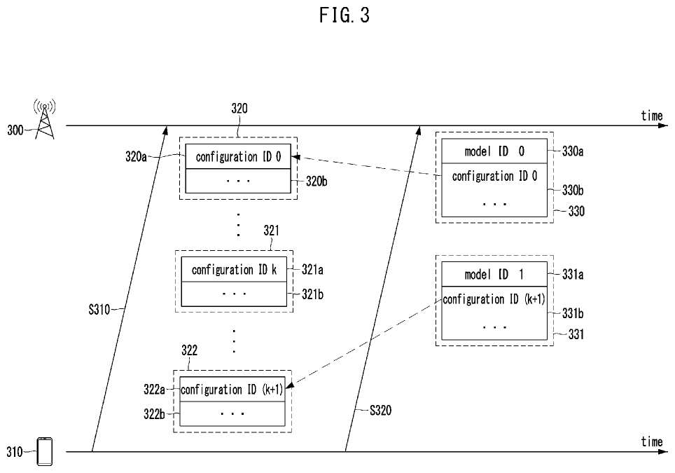

FIG. 3 is an exemplary diagram illustrating a case where a terminal reports two-stage artificial neural network model information according to the first exemplary embodiment of the present disclosure.

Referring to FIG. 3, a base station 300 and a terminal 310 are illustrated. In a non-cellular network, the base station 300 may be a transmitting node and the terminal 310 may be a receiving node. In other words, a mobile communication system may include the base station 300 and the terminal 310, and in case of a wireless communication system extending the mobile communication system, the base station 300 may be understood as a transmitting node and the terminal 310 may be understood as a receiving node. In the following description, for convenience of description, the base station 300 and the terminal 310 will be described as an example. In addition, this understanding should be applied equally in other drawings.

In a step S310, the terminal 310 may report required network configurations 320, 321, and 322 to the base station 300. The required network configurations 320, 321, and 322 may include configuration identifiers (IDs) 320a, 321a, and 322a and information 320b, 321b, and 322b corresponding to the respective IDs, as illustrated in FIG. 3. The configuration IDs 320a, 321a, and 322a may be IDs assigned by the terminal or pre-assigned by a server providing artificial neural networks. The required network configurations 320b, 321b, and 322b may be information required for the base station 300. For example, the required network configurations may include information such as a periodicity, frequency, or density of periodic CSI-RS transmission. The network configurations 320, 321, and 322 will be described further below.

The step S310 of FIG. 3 illustrates a case where there are various required network configurations that the terminal 310 can report. Therefore, the terminal may report the various required network configurations 320, 321, and 322 to the base station in the step S310.

In a step S320, the terminal 310 may transmit model status reports 330 and 331 to the base station 300. In other words, the terminal 310 may report model-specific status information for artificial neural network models to the base station. The model status reports may include model ID fields 330a and 331a and model information fields 330b and 331b for the respective artificial neural network models, as illustrated in FIG. 3. The model information fields 330b and 331b may include network configuration IDs corresponding to the model IDs, respectively.

Meanwhile, as a modified form of the first exemplary embodiment of the present disclosure, the following exemplary embodiments may be possible.

First modified example corresponding to the first exemplary embodiment: A network in which the base station and a server managing artificial neural networks of the terminal exist may be assumed.

In the first modified example, the operations of the terminal may be implemented to be processed by the server managing the artificial neural networks. When the network is configured as in the first modified example corresponding to the first exemplary embodiment, in the first-stage, the server managing the artificial neural networks of the terminal may provide detailed information on the artificial neural network models to the base station. In the second-stage, the server managing the artificial neural networks of the terminal may be configured to report a reference ID that can refer to detailed information for each artificial neural network model for each terminal to the base station.

According to the first modified example corresponding to the first exemplary embodiment, the terminal may not need to perform reporting to the base station. Therefore, since there is no need to allocate separate resources for uplink reporting, the base station may increase the efficiency of using uplink radio resources.

Second modified example corresponding to the first exemplary embodiment: A network in which a server managing artificial neural networks of the terminal and an artificial neural network model server of the network exist may be assumed.

When the network is configured as in the second modified example corresponding to the first exemplary embodiment, in the first-stage, the server managing the artificial neural networks of the terminal may provide detailed information on the artificial neural network models to the artificial neural network management server of the network not to the base station. In the second-stage, the server managing the artificial neural networks of the terminal may be configured to report, to the artificial neural network model management server of the network, a reference ID that can refer to detailed information for each artificial neural network model for each terminal.

The artificial neural network model management server of the network may provide information on artificial neural network models for a specific terminal to the base station, if necessary.

By applying the above-described configuration, the base station may obtain information on the artificial neural network from the artificial neural network model management server of the network when it needs information on the artificial neural network for the terminal located within its communication area.

The second modified example corresponding to the first exemplary embodiment also does not require the terminal to perform reporting to the base station. Therefore, since there is no need to allocate separate resources for uplink reporting, the base station may increase the efficiency of using uplink radio resources.

The first exemplary embodiment of the present disclosure described above may be applied together with other exemplary embodiments described below to the extent that they do not conflict with each other.

### Second Exemplary Embodiment

The second exemplary embodiment of the present disclosure may be applied when the following conditions are satisfied.

Condition 1: An artificial neural network for wireless communication is applied in a mobile communication system consisting of a base station and a terminal.

Condition 3: The terminal may configure and/or utilize multiple artificial neural network models for multiple functions.

According to the second exemplary embodiment of the present disclosure, when a terminal (or an upper entity/cloud/server that manages artificial neural networks of the terminal) that satisfies Condition 1 and Condition 3 reports one or more required network configurations the base station, each required network configuration may be reported as including at least one information of the following information.
(1) Configuration ID
(2) One or more radio resource configuration (RRC) information elements (IEs) corresponding to the required network configuration

In an exemplary embodiment of the present disclosure, it is assumed that the terminal supports one or more artificial neural network models for wireless communication, and that a specific required network configuration is required to apply the artificial neural network model(s).

As a specific example, as previously described in the first exemplary embodiment, it may be assumed that the terminal supports one or more CSI prediction artificial neural network model(s) aimed at CSI prediction for future times. In this case, in order for the terminal to utilize the CSI prediction artificial neural network model, the base station may need to periodically transmit CSI-RS.

Meanwhile, an authority for required network configurations is a unique authority held by the network or base station. Therefore, when the terminal desires to use an artificial neural network model and it needs a specific required network configuration, the terminal may need to be able to request the required network configuration from the base station. Accordingly, when the terminal supports one or more artificial neural network models for wireless communication and requires a specific network configuration to apply the artificial neural network model(s), the required network configuration needs to be reported to the base station.

As a method for the terminal to report the required network configuration to the base station, the existing method used by the terminal to be configured with a required network configuration may be used. For example, in 3GPP 4G LTE and 5G NR systems, the terminal may receive required network configuration through RRC signaling. In addition, the terminal may also transmit information such as terminal capabilities to the network through RRC signaling. Accordingly, when the terminal according to the present disclosure reports the required network configuration for the artificial neural network model to the base station, it may report in form of RRC signaling. In addition, when the required network configurations need to be distinguished from each other, the terminal may report one or more required network configurations to the base station. When the terminal reports one or more required network configurations to the base station, a configuration ID may be assigned to each required network configuration so that different required network configurations can be distinguished.

This will be described with reference to FIG. 3. For example, a case where two CSI prediction artificial neural network models (i.e., model 0 and model 1) used by the terminal 310 exist may be considered. The model 0 and model 1 may be models with different prediction time intervals. For example, the model 0 may require CSI-RS resources having a periodicity of 5 ms, and the model 1 may require CSI-RS resources having a periodicity of 10 ms.

In addition, when the first exemplary embodiment is applied, the terminal 310 may report the required network configurations and IDs corresponding thereto in advance to the base station 300. As another example, the base station 300 may be in a state of having provided IDs for configurable network configurations and information on the configurable network configurations to the terminal 310 in advance. Hereinafter, for convenience of description, description will be made assuming that the first-stage report is transmitted from the terminal 310 to the base station 300 as in the first exemplary embodiment.

As in the above example, when the model 0 and model 1 with different required network configurations can be utilized, the terminal 310 may assign a configuration ID 0 320a as a configuration ID corresponding a required network configuration (i.e., CSI-RS resource configuration for the model 0 having a periodicity of 5 ms). In addition, the terminal 310 may assign a configuration ID (k+1) 322a as a configuration ID corresponding a required network configuration (i.e., CSI-RS resource configuration for the model 1 having a periodicity of 10 ms). The terminal 310 may transmit artificial neural network model status reports 330 and 331 including the required network configurations assigned in the above-described manner to the base station 300.

The second exemplary embodiment of the present disclosure described above may be applied together with the first exemplary embodiment described above. Further, the second exemplary embodiment of the present disclosure may be applied together with other exemplary embodiments described below to the extent that they do not conflict with each other.

### Third Exemplary Embodiment

The third exemplary embodiment of the present disclosure may be applied when the following conditions are satisfied.

Condition 1: An artificial neural network for wireless communication is applied in a mobile communication system consisting of a base station and a terminal.

Condition 3: The terminal may configure and/or utilize multiple artificial neural network models for multiple functions.

According to the third exemplary embodiment of the present disclosure, when a terminal (or an upper entity/cloud/server that manages artificial neural networks of the terminal) that satisfies Condition 1 and Condition 3 reports one or more required network configurations the base station, mode-specific status information for each artificial neural network model may be reported as including at least one information of the following information.
(1) Model identifier (ID)
(2) Information on a required network configuration for artificial neural network model-based inference task
(3) Information on an auxiliary network configuration for artificial neural network model-based inference task
(4) Model performance indicator
(5) Preference or priority information for each model

In this case, when reporting model-specific status information, the terminal (or, upper entity/cloud/server that manages the artificial neural networks of the terminal) may report artificial neural network model-specific status information to the base station for each functionality targeted by the artificial neural network model.

The auxiliary network configuration (e.g., assistance information) may be a configuration that can be selectively utilized when performing the artificial neural network model-based inference task.

In addition, the required network configuration information and/or auxiliary network configuration information may be one or more RRC IEs corresponding to the network configurations or reference information that can refer to previously reported network configurations.

Further, the model performance indicator may be expressed as a signal to interference plus noise ratio (SINR) gain for a data channel and/or reference signal, assuming a specific transmission scheme.

The terminal may transmit a model status report in form of an RRC or MAC layer signaling.

As an exemplary embodiment of the present disclosure, it is assumed that the terminal supports one or more artificial neural network models for wireless communication, and that a specific required network configuration is required to apply the artificial neural network model(s).

As a specific example, as previously described in the first exemplary embodiment, it is assumed that the terminal supports one or more CSI prediction artificial neural network models aimed at CSI prediction for future times. In this case, in order for the terminal to utilize the CSI prediction artificial neural network model, the base station may need to periodically transmit CSI-RS.

Meanwhile, authority for network configurations is a unique authority held by the network or base station. Therefore, if the terminal needs a specific network configuration when it desires to use an artificial neural network model, the terminal may need to be able to deliver the required network configuration for each artificial neural network model to the base station. The terminal may deliver two types of information to the base station to utilize the terminal's artificial neural network.

The first is information on a list of artificial neural network models that the terminal can currently support. For example, it may be list information of artificial neural network models as reported in the second-stage described in the first exemplary embodiment. In addition, the list information of artificial neural network models that the terminal can currently support may be the list information of the artificial neural network model information described in the second exemplary embodiment.

The second is the network configuration required for each model. The network configuration required for each model may be the same information as that of the second exemplary embodiment described above.

The operations described above will be described with reference to FIG. 3.

The terminal 310 may transmit model status reports 330 and 331 including model ID fields 330a and 331a and model information fields 330b and 331b for one or more artificial neural network model(s), respectively, to the base station 300. The network configuration information may be one or more RRC IEs corresponding to a network configuration, or may be reference information that refers to the previously reported network configuration. The network configuration information may include required network configuration information and/or auxiliary network configuration information according to the third exemplary embodiment of the present disclosure.

In addition, when performing the model status reporting as in the step S320, the terminal 310 may report model performance indicators for the respective artificial neural network models to the base station 300 in the model information fields 330b and 331b. The base station 300 may determine whether to allow an artificial neural network model corresponding to the performance indicator based on the model performance indicator for each artificial neural network model received. The model performance indicator may be expressed as an SINR gain for a data channel and/or reference signal assuming a specific transmission scheme. For example, a demodulation reference signal (DM-RS) SINR, CSI-RS SINR, synchronization signal block (SSB) SINR, etc. may be applicable.

In addition, when performing the model status reporting as in the step S320, the terminal 310 may report model-specific preference or priority information to the base station 300 in the model information fields 330b and 331b. Therefore, the base station may determine an artificial neural network model to be used by referring to the model-specific preference or priority information reported by the terminal 310.

The third exemplary embodiment of the present disclosure described above may be applied together with the first to second exemplary embodiments described above. Further, the third exemplary embodiment of the present disclosure may be applied together with other exemplary embodiments described below to the extent that they do not conflict with each other.

### Fourth Exemplary Embodiment

The fourth exemplary embodiment of the present disclosure may be applied when the following conditions are satisfied.

Condition 1: An artificial neural network for wireless communication is applied in a mobile communication system consisting of a base station and a terminal.

Condition 3: The terminal may configure and/or utilize multiple artificial neural network models for multiple functions.

According to the fourth exemplary embodiment of the present disclosure, when a terminal (or an upper entity/cloud/server that manages artificial neural networks of the terminal) that satisfies Condition 1 and Condition 3 reports model-specific status information for one or more artificial neural network models to the base station, the terminal (or upper entity/cloud/server that manages the artificial neural networks of the terminal) may report one or more required network configurations in advance. In addition, when the terminal (or upper entity/cloud/server that manages artificial neural networks of the terminal) that satisfies Condition 1 and Condition 3 reports the model-specific status information to the base station, model-specific network configuration may be reported using ID(s) of the previously reported network configuration.

As an exemplary embodiment of the present disclosure, it is assumed that the terminal supports one or more artificial neural network models for wireless communication, and that a specific network configuration is required to apply the artificial neural network model(s).

Specifically, as described in the first exemplary embodiment described above, it is assumed that the terminal supports one or more artificial neural network model(s) aimed at CSI prediction for future times. In this case, in order for the terminal to utilize the CSI prediction artificial neural network model, the base station may need to transmit periodic CSI-RS. In addition, the terminal may divide information on the one or more artificial neural network models, and report it to the base station in two stages as described in the first exemplary embodiment.

For example, when reporting in the first-stage, one or more required network configurations may be reported, and when reporting in the second-stage, artificial neural network model-specific status information for the one or more artificial neural network model(s) may be reported. In addition, when reporting the model status including the required network configuration for each artificial neural network model, a report may be made in a form referring to a network configuration reported in the first-stage.

Under the above assumption, the terminal may report to the base station by including a configuration ID for each network configuration in the first-stage report, and report information on a required network configuration for each model using the configuration ID of the network configuration pre-reported in the second-stage report. Since the configuration ID is expressed with a very small signal transmission load compared to the entire network configuration, when operating according to the present disclosure, a signal transmission load of the second-stage report, that is, the model status report, may be very small. Therefore, when the terminal desires to actively change the status of the artificial neural network model, it may make the change and quickly report the changed model status to the base station with a small signal transmission load.

The fourth exemplary embodiment of the present disclosure described above may be applied together with the first to third exemplary embodiments described above. Further, the fourth exemplary embodiment of the present disclosure may be applied together with other exemplary embodiments described below to the extent that they do not conflict with each other.

### Fifth Exemplary Embodiment

The fifth exemplary embodiment of the present disclosure may be applied when the following conditions are satisfied.

Condition 1: An artificial neural network for wireless communication is applied in a mobile communication system consisting of a base station and a terminal.

Condition 3: The terminal may configure and/or utilize multiple artificial neural network models for multiple functions.

According to the fifth exemplary embodiment of the present disclosure, a terminal (or an upper entity/cloud/server that manages artificial neural networks of the terminal) that satisfies Condition 1 and Condition 3 performs model status reporting including model-specific status information for one or more artificial neural network models to the base station, the terminal (or upper entity/cloud/server that manages the artificial neural networks of the terminal) may include only status information for currently-supportable artificial neural network model(s) in the model status report. Then, the base station receiving the model status report may determine whether the terminal supports a specific artificial neural network model based on whether or not the terminal's model status report includes status information of the specific artificial neural network model.

In this case, the terminal (or upper entity/cloud/server that manages the artificial neural networks of the terminal) may transmit a blank model status report that does not include any artificial neural network model-specific status information. The blank model status report may be interpreted as expressing a state in which there is no artificial neural network model that can be supported by the terminal (or upper entity/cloud/server that manages the artificial neural networks of the terminal).

As an exemplary embodiment of the present disclosure, a case where the terminal that satisfies Condition 1 can report a status of the artificial neural network model(s) it supports to the base station may be assumed. In general, artificial neural networks have the advantage of being capable of continuous and adaptive learning. Therefore, even after the terminal is released as a commercial version, the artificial neural network model(s) supported by the terminal may be continuously updated. Accordingly, the artificial neural network model(s) mounted on the terminal may be changed in real time.

In this case, if the terminal has not yet received an artificial neural network model distributed from a cloud or over-the-top (OTT) server that manages its artificial neural networks, the terminal may be obviously unable to support the artificial neural network model. In addition, after the artificial neural network model is distributed, if it is determined that the artificial neural network model is not suitable to a current environment due to a data drift phenomenon, or if an update therefor is in progress for a certain reason, support for the artificial neural network model may be temporarily suspended.

As another example, support for the existing artificial neural network model may be stopped or lightened due to a specific reason of the terminal. For example, when the terminal generates an excessive heat and computational load due to data transmission and reception based on carrier aggregation (CA), the terminal may stop supporting the previously-provided artificial neural network model(s), or may support the existing model(s) by replacing the existing model(s) with lightweight model(s).

Considering a use case where the terminal actively changes the artificial neural network model(s) as described above, it may be preferable to support the terminal to report models that it can currently support in real time.

Therefore, in the present disclosure, when the terminal reports model-specific status information for one or more artificial neural network model(s) to the base station, that is, a model status of the terminal, the terminal may include only status information on the currently supportable artificial neural network model(s) in the model status report. In addition, the base station may determine whether a specific artificial neural network model is supported by the terminal by whether or not the terminal's model status report includes status information of the specific artificial neural network model.

In other words, the terminal and the base station may implicitly agree to interpret whether status information of a specific artificial neural network model is included in the terminal's model status report as whether or not the specific artificial neural network model is currently supported by the terminal.

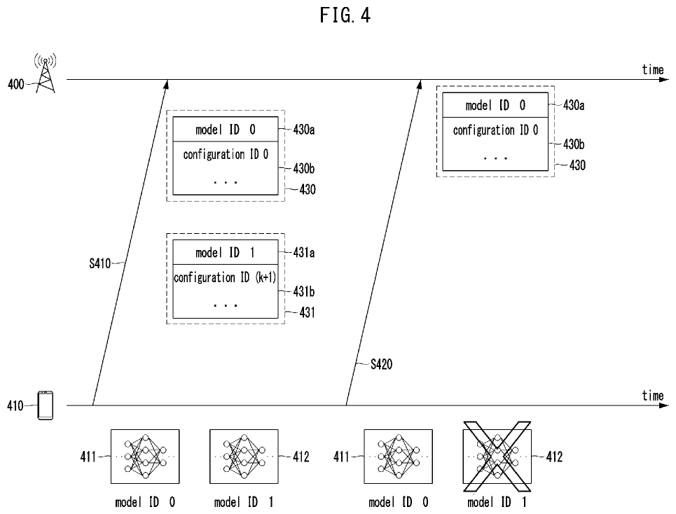

FIG. 4 is a conceptual diagram illustrating an operation of reporting artificial neural network model statuses so that only models that the terminal can currently support are included in the reporting according to the fifth exemplary embodiment of the present disclosure.

Referring to FIG. 4, in a step S410, a terminal 410 may transmit model status reports 430 and 431 to a base station 400. The model status reports 430 and 431 may include model ID fields 430a and 431a and model information fields 430b and 431b of artificial neural network models, respectively, as previously described in the first to fourth exemplary embodiments. In the example of FIG. 4, the terminal 410 may use a model 0 411 and a model 1 412, and in the step S410, a case where both models 411 and 412 are available for use is illustrated.

Therefore, in the step S410, the terminal 310 may transmit a model-specific status information report message including a model ID and required network configuration corresponding to each of the artificial neural network model 0 411 and the artificial neural network model 1 412.

In a step S420, a case is exemplified where the terminal cannot use the artificial neural network model 1 412 for a specific reason. Accordingly, when transmitting a model status report message to the base station 300 in the step S420, the terminal 310 may configure the model status report including only status information of the available model. In other words, the model status report transmitted in the step S420 may include only the model status report 430 for the artificial neural network model 0.

As another example, among the status information reports for the respective model statuses, a model status information report corresponding to the model ID 1 412 may include only the model ID 431a in the model ID field, and the model information field 431b thereof may be set to ‘0’.

The fifth exemplary embodiment of the present disclosure described above may be applied together with the first to fourth exemplary embodiments described above. Further, the fifth exemplary embodiment of the present disclosure may be applied together with other exemplary embodiments described below to the extent that they do not conflict with each other.

### Sixth Exemplary Embodiment

The sixth exemplary embodiment of the present disclosure may be applied when the following conditions are satisfied.

Condition 1: An artificial neural network for wireless communication is applied in a mobile communication system consisting of a base station and a terminal.

Condition 3: The terminal may configure and/or utilize multiple artificial neural network models for multiple functions.

According to the sixth exemplary embodiment of the present disclosure, when a terminal (or an upper entity/cloud/server that manages artificial neural networks of the terminal) that satisfies Condition 1 and Condition 3 reports artificial neural network model-specific status information for one or more artificial neural network models to the base station, the terminal may perform the reporting when at least one of the following conditions is satisfied.
(1) When model status information of the terminal changes
(2) When the base station indicates the terminal to report the model status
(3) When a retransmission prohibition timer for model status information reporting expires and there is an artificial neural network model currently supported by the terminal
(4) When a periodic transmission timer for model status information reporting expires and there is an artificial neural network model currently supported by the terminal
(5) When a handover procedure occurs

Here, the retransmission prohibition timer for model status information reporting may be a timer for a purpose of prohibiting retransmission for a time length of the timer from a time point at which the terminal performed model status information reporting.

In addition, the periodic transmission timer for model status information reporting may be a timer for a purpose of inducing model status reporting from the terminal periodically at a periodicity of a time length of the timer.

According to the sixth exemplary embodiment of the present disclosure, it is assumed that the terminal supports one or more artificial neural network models for wireless communication and can report a status of the artificial neural network model(s) it supports to the base station. In this case, the model status information reporting may be done in the following cases.

First, the model status information reporting may be triggered by the base station. For example, the base station may indicate the terminal through a control signal to report the status of the currently supportable artificial neural network model(s). The control signal through which the base station triggers the model status reporting of the terminal may be transmitted in form of signaling such as dynamic control information (DCI), MAC control element (CE), and RRC.

Second, even when there is no explicit indication from the base station, the terminal may perform model status reporting on its own. For example, the terminal may actively change information on currently-supportable model(s) for reasons such as distribution of artificial neural network models, update of artificial neural network models, computational load control, and heat control. When information on the currently-supportable model(s) is changed, the terminal may report status information of the changed models to the base station without an indication from the base station. If the status of the supportable artificial neural network model has changed compared to the previously reported status, the terminal may report information on the changed model status.

In addition, in the sixth exemplary embodiment of the present disclosure, the model status reporting may be performed based on a timer of a MAC layer, which is set by the base station, similarly to a Buffer Status Report (BSR) transmission scheme in the 3GPP 4G LTE and 5G NR systems. For example, the base station may set a first timer and a second timer for model status reporting to the terminal. Thereafter, the terminal may periodically start the first timer, and when the first timer expires and there is an artificial neural network model currently supported by the terminal, the terminal may perform the model status reporting to the base station. The first timer may be defined similarly to a timer (e.g., periodicBSR-Timer) for triggering a periodic BSR in the 3GPP 4G LTE and 5G NR systems.

In addition, the terminal may start the second timer when the model status reporting is performed, and after the second timer expires, if there is an artificial neural network model currently supported by the terminal, the terminal may perform the model status reporting to the base station. The second timer may be defined similarly to a timer (e.g., retxBSR-Timer) for triggering a regular BSR in the 3GPP 4G LTE and 5G NR systems.

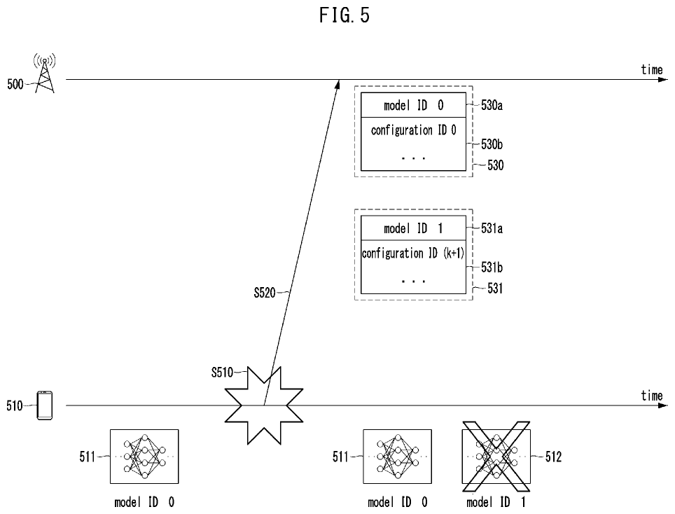

FIG. 5 is a conceptual diagram for describing an operation according to an artificial neural network model status reporting trigger of a terminal according to the sixth exemplary embodiment of the present disclosure.

The sixth exemplary embodiment described above will be described with reference to FIG. 5. Referring to FIG. 5, a terminal 510 may be in a state of capable of using an artificial neural network model 0 511. Therefore, the terminal 510 may have previously reported a model status of the artificial neural network model 0 511 to a base station 500. In this case, a trigger for changing the status of the artificial neural network model may occur, as in a step S510. The trigger may corresponding to a case when use of a specific artificial neural network model needs to be stopped, or a case when a new artificial neural network model becomes available, as described above.

FIG. 5 illustrates a case where the artificial neural network model 0 511 and an artificial neural network model 1 512 are available, and the artificial neural network model 1 512 becomes newly available. Accordingly, the terminal 510 may perform model status reporting for the artificial neural network model 0 511 and model status reporting for the artificial neural network model 1 512 in a step S520. In this case, model status report messages for the artificial neural network models 511 and 512 may include model ID fields 530a and 531a and model information fields 530b and 531b, respectively, as described in the previous exemplary embodiments.

The sixth exemplary embodiment of the present disclosure described above may be applied together with the first to fifth exemplary embodiments described above. Further, the sixth exemplary embodiment of the present disclosure may be applied together with other exemplary embodiments described below to the extent that they do not conflict with each other.

### Seventh Exemplary Embodiment

The seventh exemplary embodiment of the present disclosure may be applied when the following conditions are satisfied.

Condition 1: An artificial neural network for wireless communication is applied in a mobile communication system consisting of a base station and a terminal.

Condition 3: The terminal may configure and/or utilize multiple artificial neural network models for multiple functions.

According to the seventh exemplary embodiment of the present disclosure, when a terminal (or an upper entity/cloud/server that manages artificial neural networks of the terminal) that satisfies Condition 1 and Condition 3 reports model-specific status information for one or more artificial neural network models to a base station, the base station may indicate whether to activate/deactivate each model (hereinafter referred to as ‘model activation/deactivation’) for the one or more artificial neural network models based on the model status reporting. In addition, the present disclosure proposes a method where model-specific activation/deactivation information within the model activation/deactivation includes at least one of the following information.
(1) Model identifier (ID)
(2) Whether to activate/deactivate a model or whether to apply or not apply a model

In this case, the terminal (or upper entity/cloud/server that manages the artificial neural networks of the terminal) may ignore activation/deactivation requests for model IDs that are not included in the model status reporting.

In addition, the model activation/deactivation may indicate whether to apply an artificial neural network model of the terminal. Alternatively, it may be possible to indicate whether to allow the artificial neural network model of the terminal. In the latter case, even when the base station allows the terminal's artificial neural network model, the terminal may decide on its own whether to actually apply or not apply the model.

In the seventh exemplary embodiment of the present disclosure, it is assumed that the terminal supports one or more artificial neural network models for wireless communication, and the terminal can report a status of the artificial neural network model(s) it supports to the base station.

The base station may indicate to the terminal artificial neural network models to activate actual operations thereof based on information on the artificial neural network model(s) reported by the terminal. For example, the terminal may report to the base station a plurality of currently-supportable artificial neural network model(s), including required network configuration information and artificial neural network model performance indicators for the respective artificial neural network models. Then, the base station may inform the terminal whether to activate or deactivate each artificial neural network model by considering a performance gain and a system load for each artificial neural network model.

Activation/deactivation information for each model may include at least a target model ID and whether to activate or deactivate a model corresponding to the target model ID. In this case, the model activation/deactivation may indicate whether or not to apply the terminal's artificial neural network model, or may indicate whether or not to allow the terminal's artificial neural network model. In the latter case, even when the base station allows the terminal's artificial neural network model, the terminal may decide on its own whether to actually apply or not apply the model.

The seventh exemplary embodiment of the present disclosure described above may be applied together with the first to sixth exemplary embodiments described above. Further, the seventh exemplary embodiment of the present disclosure may be applied together with other exemplary embodiments described below to the extent that they do not conflict with each other.

### Eighth Exemplary Embodiment

The eighth exemplary embodiment of the present disclosure may be applied when the following conditions are satisfied.

Condition 1: An artificial neural network for wireless communication is applied in a mobile communication system consisting of a base station and a terminal.

Condition 3: The terminal may configure and/or utilize multiple artificial neural network models for multiple functions.

According to the eighth exemplary embodiment of the present disclosure, a terminal (or an upper entity/cloud/server that manages artificial neural networks of the terminal) that satisfies Condition 1 and Condition 3 may report model-specific status information for one or more artificial neural network models to a base station. In addition, when the base station indicates whether or not to activate each model for the one or more artificial neural network models based on the model status reporting as in the seventh exemplary embodiment described above, if the base station receives a model status report of the terminal (or upper entity/cloud/server that manages artificial neural networks of the terminal) with respect to the currently-activated artificial neural network model, the base station may perform one or more of the following operations.
(1) Ignore the terminal's model status report for the activated artificial neural network model
(2) When there is a model status change for the activated artificial neural network model, perform a model deactivation process for the artificial neural network model

Here, the model deactivation process may include a process where the base station indicates the terminal to deactivate the specific artificial neural network model and/or a process where the base station manages the status of the specific artificial neural network model as a status of being not supportable by the terminal.

In addition, when the base station ignores the terminal's model status report for the activated artificial neural network model, the terminal may need to maintain a supportable state for the activated artificial neural network model of the terminal.

In addition, the model activation/deactivation may indicate whether or not to apply the terminal's artificial neural network model, or may indicate whether or not to allow the terminal's artificial neural network model. In the latter case, even when the base station allows the terminal's artificial neural network model, the terminal may decide on its own whether to actually apply or not apply the model.

It may be assumed that the terminal supports one or more artificial neural network models for wireless communication and can report a status of the artificial neural network model(s) to the base station. According to the eighth exemplary embodiment of the present disclosure, the base station may indicate to the terminal artificial neural network models to activate actual operations thereof based on information on the artificial neural network model(s) reported by the terminal.

For example, the terminal may report to the base station a plurality of currently-supportable artificial neural network model(s), including required network configuration information and artificial neural network model performance indicators for the respective artificial neural network models. Then, the base station may inform the terminal whether to activate/deactivate each artificial neural network model by considering a performance gain and a system load for each artificial neural network model. When the terminal notifies the base station that there is a change in the already activated artificial neural network model through a model status report, ambiguity in model status recognition between the base station and the terminal may occur.

For example, it may be assumed that the terminal reports that it can support a specific artificial neural network model and the base station indicates activation of the specific artificial neural network model. Thereafter, the terminal may report a model status indicating that the corresponding model is not supportable. In this case, if the base station accepts the terminal's model status report, an error situation may occur in which the base station indicates activation of the artificial neural network model that the terminal reported as unsupportable.

Accordingly, the eighth exemplary embodiment of the present disclosure provides a method for eliminating this discrepancy.

First, when the base station receives the terminal's model status report for the currently activated artificial neural network model, it may consider ignoring the terminal's model status report for the currently activated artificial neural network model. If the base station ignores the terminal's model status report for the activated artificial neural network model received from the terminal, the terminal may need to maintain a supportable state for the activated artificial neural network model of the terminal. In other words, the terminal may not allow a behavior of changing the model status of the activated artificial neural network model.

As another example, if there is a model status change for the activated artificial neural network model in the terminal as a result of the base station receiving the terminal's model status report for the currently activated artificial neural network model, a method of performing a model deactivation process for the artificial neural network model may be considered. The model deactivation process may include a process where the base station indicates the terminal to deactivate the specific artificial neural network model and/or a process where the base station manages the specific artificial neural network model in a state in which the terminal does not support it. In other words, since the terminal does not support the currently activated artificial neural network model, the base station may also recognize that the artificial neural network model is no longer supported and attempt to deactivate the model.

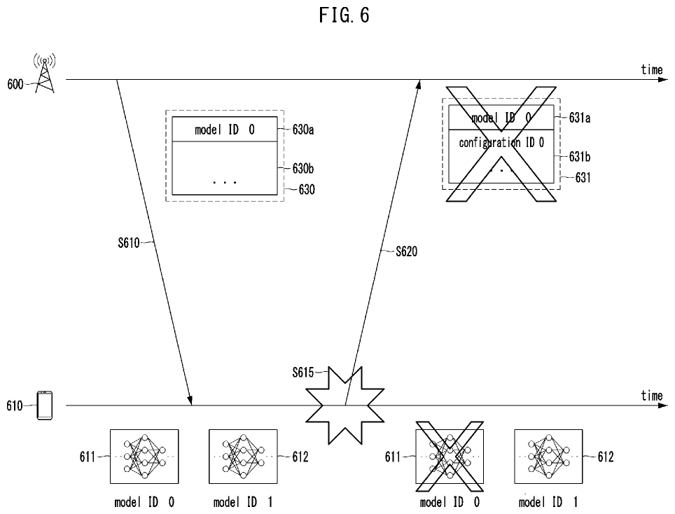

FIG. 6 is a conceptual diagram illustrating an operation based on a model status reporting process for an activated artificial neural network model according to the eighth exemplary embodiment of the present disclosure.

The eighth exemplary embodiment described above will be described with reference to FIG. 6. Referring to FIG. 6, a case where a terminal 610 is able to use an artificial neural network model 0 611 and an artificial neural network model 1 612 is illustrated. In addition, based on the exemplary embodiments described above, the terminal 610 may have reported information on the artificial neural network models to a base station 600.

In a step S610, the base station 600 may indicate whether or not to activate or whether or not to apply the artificial neural network model 0 611 as one of artificial neural network models to be used. Indication information 630 for this may include an artificial neural network model ID field 630a and an activation field 630b. The activation field 630b may indicate whether the artificial neural network model is activated or whether the artificial neural network model is applied. The exemplary embodiment of FIG. 6 illustrates a case where the base station 600 indicates to activate or apply the artificial neural network model 0 611.

The terminal 610 may activate or apply the artificial neural network model 0 611 based on the indication from the base station 600. Thereafter, for a certain reason, the use of artificial neural network model 0 611 may become impossible in a step S615. When the use of the artificial neural network becomes impossible, the terminal 610 may transmit a model status report 631 for the artificial neural network model 1 612, which is an available artificial neural network, in a step S620. As described above, the model status report 631 may include an artificial neural network model ID field 631a and a model information field 631b.

When the base station 600 receives the model status report 630 from the terminal 610 in step S620, the base station 600 may ignore the model status report 630. As another example, the base station 600 may deactivate the artificial neural network model 0 611 currently in use. In this case, as described above, the base station 600 may perform a procedure to deactivate the artificial neural network model 0 611 in use. It may be noted that FIG. 6 does not illustrate the procedure for deactivating the artificial neural network model 0 611 in use.

The eighth exemplary embodiment of the present disclosure described above may be applied together with the first to seventh exemplary embodiments described above. Further, the eighth exemplary embodiment of the present disclosure may be applied together with other exemplary embodiments described below to the extent that they do not conflict with each other.

### Ninth Exemplary Embodiment

The ninth exemplary embodiment of the present disclosure may be applied when the following conditions are satisfied.

Condition 1: An artificial neural network for wireless communication is applied in a mobile communication system consisting of a base station and a terminal.

Condition 3: The terminal may configure and/or utilize multiple artificial neural network models for multiple functions.

According to the ninth exemplary embodiment of the present disclosure, when a terminal (or an upper entity/cloud/server that manages artificial neural networks of the terminal) that satisfies Condition 1 and Condition 3 reports model-specific status information for one or more artificial neural network models to a base station, it may report status information of an artificial neural network model (i.e., base station-sided artificial neural network model) that should be paired at the base station for a joint inference task for each artificial neural network model (i.e., terminal-sided artificial neural network model) of the terminal. In addition, the status information of the base station-sided artificial neural network model may be reported including at least one of the following information.
(1) Existence of the base station-sided artificial neural network model
(2) Identifier (Model ID) of the base station-sided artificial neural network model
(3) Input and/or output of the base station-sided artificial neural network model
(4) Information on an execution environment of the base station-sided artificial neural network model
(5) Time (i.e., inference latency) required for an inference operation of the base station-sided artificial neural network model

In an exemplary embodiment of the present disclosure, it is assumed that the terminal supports one or more artificial neural network models for wireless communication and can report a status of the artificial neural network model(s) it supports to the base station. Meanwhile, the international standardization organization such as 3GPP is discussing a two-sided AI/ML model in which artificial neural network models exist separately at the base station and terminal in the AI/ML study for NR air interfaces.

In the case of a two-sided AI/ML model, a terminal-sided artificial neural network model and a base station-sided artificial neural network model are paired, and the two artificial neural network models jointly perform inference tasks. For example, when configuring a two-sided AI/ML model for CSI compression, a terminal-sided artificial neural network model may be an artificial neural network model that encodes CSI information, and a base station-sided artificial neural network model may be an artificial neural network model that decodes CSI information.

When reporting status information on artificial neural network model(s) supported by the terminal, the terminal may consider a two-sided AI/ML model and report status information of a base station-sided artificial neural network model paired with its own artificial neural network model. The status information of the base station-sided artificial neural network model may include presence or absence of the base station-sided artificial neural network model according to the two-sided AI/ML model, ID of the model, input and output of the model, environment for execution of the model, time required for execution of the model, support information generated when executing the model, and/or the like.

The ninth exemplary embodiment of the present disclosure described above may be applied together with the first to eighth exemplary embodiments described above. Further, the ninth exemplary embodiment of the present disclosure may be applied together with other exemplary embodiments described below to the extent that they do not conflict with each other.

### Tenth Exemplary Embodiment

The tenth exemplary embodiment of the present disclosure may be applied when the following conditions are satisfied.

Condition 1: An artificial neural network for wireless communication is applied in a mobile communication system consisting of a base station and a terminal.

Condition 3: The terminal may configure and/or utilize multiple artificial neural network models for multiple functions.

According to the tenth exemplary embodiment of the present disclosure, when a terminal (or an upper entity/cloud/server that manages artificial neural networks of the terminal) reports model-specific status information for one or more artificial neural network models to a base station, if the terminal reports status information of an artificial neural network model (i.e., base station-sided artificial neural network model) that should be paired at the base station for a joint inference task for each artificial neural network model (i.e., terminal-sided artificial neural network model) of the terminal, the status information of the base station-sided artificial neural network model may be obtained in one or more of the following manners.
(1) A method in which the terminal configures a base station-sided artificial neural network model that should be paired with the terminal's artificial neural network model for a joint inference task, and obtains status information of the base station-sided artificial neural network model therefrom.
(2) A method in which the terminal receives one or more base station-sided artificial neural network models that should be paired with the artificial neural network model of the terminal for a joint inference task from the base station, and obtains status information of the base station-sided artificial neural network model(s) therefrom.

In this case, the base station may deliver also information on a terminal-sided artificial neural network model that operates as being paired with the base station-sided artificial neural network model to the terminal, and if the terminal-sided artificial neural network model is applicable, the terminal may report it to the base station by including it in a model status report.

In the tenth exemplary embodiment of the present disclosure, it is assumed that the terminal supports one or more artificial neural network models for wireless communication and can report a status of the artificial neural network model(s) it supports to the base station. Meanwhile, the international standardization organization such as 3GPP is discussing a two-sided AUML model in which artificial neural network models exist separately at the base station and terminal in the AUML study for NR air interfaces. In the case of a two-sided AUML model, a terminal-sided artificial neural network model and a base station-sided artificial neural network model are paired, and the two artificial neural network models jointly perform inference tasks.

When taking the same example as previously described in the ninth exemplary embodiment, when configuring a two-sided AUML model for CSI compression, a terminal-sided artificial neural network model may be an artificial neural network model that encodes CSI information, and a base station-sided artificial neural network model may be an artificial neural network model that decodes CSI information. When reporting status information on the artificial neural network model(s) supported by the terminal, the terminal may consider a two-sided AI/ML model and report status information of a base station-sided artificial neural network model to be paired with its own artificial neural network model. In this case, the status information of the base station-sided artificial neural network model may be obtained in two manners.

First, it is possible to consider a method in which the terminal configures a base station-sided artificial neural network model that should be paired with the terminal's artificial neural network model for a joint inference task, and then obtains status information of the base station-sided artificial neural network model(s) therefrom. In this case, the base station may recognize presence of a base station-sided artificial neural network belonging to the two-sided AI/ML model from the terminal's model status report, and request a model delivery for the base station-sided artificial neural network model it wishes to support. After receiving the model, the base station may review applicability of the base station-sided model, make a final decision on whether to activate/deactivate the pair of the corresponding terminal-sided artificial neural network model and the base station-sided artificial neural network model, and inform the final decision to the terminal.

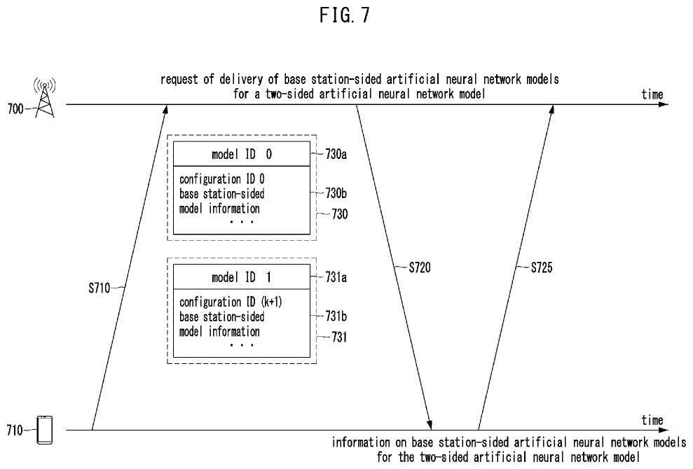

FIG. 7 is a conceptual diagram for describing operations according to model status reporting and activation for a two-sided AI/ML model according to the tenth exemplary embodiment of the present disclosure.

Referring to FIG. 7, a terminal 710 may transmit model status reports 730 and 731 for artificial neural network models to a base station 700 in a step S710. In this case, the model status reports 730 and 731 may include model ID fields 730a and 731a and model information fields 730b and 731b, respectively. Each of the model information fields 730b and 731b may include required network configurations. In addition, each of the model information fields 730b and 731b may include information on a base station-sided model. The required network configurations may be transmitted using the network configuration IDs previously transmitted in the first-stage transmission, as previously described in FIG. 3. In addition to the network configurations, other information required by the model ID may be included, for example, information on the base station-sided model.

After receiving the model status reports 730 and 731, the base station 700 may recognize existence of a base station-sided artificial neural network model belonging to a two-sided AI/ML model based on the information included in the model status reports. Therefore, the base station 700 may transmit a model delivery request for the base station-sided artificial neural network model to the terminal 710 in a step S720.

When the terminal 710 receives the model delivery request for the base station-sided artificial neural network model from the base station in a step S725, the terminal 710 may transmit information on the base station-sided artificial neural network model for the two-sided artificial neural network model to the base station 700.

After receiving information on the base station-sided artificial neural network model in the step S725, the base station 700 may review applicability of the base station-sided model, make a final decision on whether to activate/deactivate the pair of the corresponding terminal-sided artificial neural network model and the base station-sided artificial neural network model, and inform the final decision to the terminal (not shown in FIG. 7).

In the above, the operation in which the terminal transmits information of an artificial neural network model for a joint inference task with the base station to the base station has been described. Hereinafter, a method in which the base station transmits information of an artificial neural network model for a joint inference task between the base station and the terminal to the terminal will be described.

Second, the terminal may receive one or more base station-sided artificial neural network models that should be paired with the terminal's artificial neural network model for a joint inference task from the base station. The terminal may consider obtaining status information of the base station-sided artificial neural network model(s) based on the information transmitted from the base station.

In the above case, the base station may inform the terminal of existence of the two-sided AI/ML model in advance. Thereafter, the terminal may request a model delivery for the terminal-sided artificial neural network model from the base station. After receiving the model, the terminal may review applicability of the model. Based on a result of the review, the terminal may include the terminal-sided artificial neural network model for the two-sided AI/ML model in its model status report. Here, when the base station delivers the terminal-sided artificial neural network model, it may transmit it including status information of base station-sided artificial neural network model(s) to be paired according to the two-sided AI/ML model structure. The terminal may report status information of the base station-sided artificial neural network model(s) received from the base station by including it in a model status report, which may mean that it can support the two-sided AI/ML model delivered by the base station.

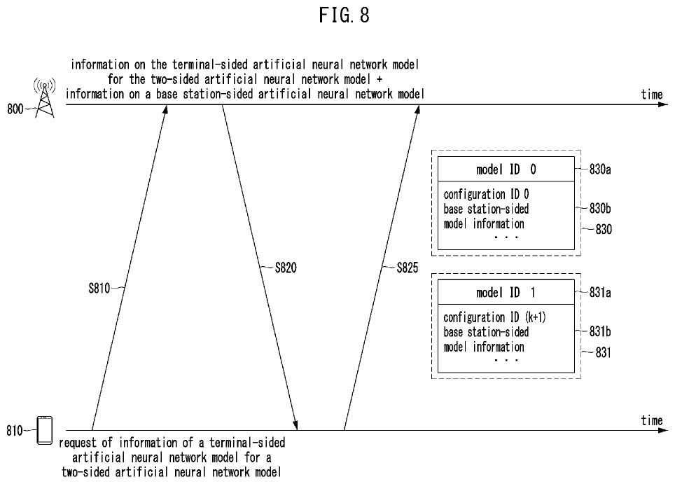

FIG. 8 is a conceptual diagram for describing operations according to model status reporting and activation for a two-sided AI/ML model according to the tenth exemplary embodiment of the present disclosure.

It is assumed that before the operation of FIG. 8 is performed, a base station 800 notifies a terminal 810 of existence of a two-sided AI/ML model. In this case, the terminal 810 may request a model delivery for a terminal-sided artificial neural network model from the base station 800 in a step S810.

In response to the model delivery request for the terminal-sided artificial neural network model from the terminal 810, the base station 800 may deliver information on a terminal-sided artificial neural network model and information on a base station-sided artificial neural network model for the two-sided artificial neural network model.

In a step S820, the terminal 810, which has received information on the terminal-sided artificial neural network and information on the base station-sided artificial neural network for the two-sided artificial neural network model mat review (or identify) whether the corresponding model is applicable. When application of at least one artificial neural network model is determined to be applicable based on the received information on the artificial neural network models, the terminal may transmit model status reports 830 and 831 for the applicable artificial neural network model(s) to the base station 800 in a step S825.

FIG. 8 illustrates a case where the terminal notifies that an artificial neural network model 1 and an artificial neural network model 2 are applicable. Accordingly, the terminal 810 may transmit model status reports 830 and 831 to the base station 800. Here, the model status reports 830 and 831 may include artificial neural network model ID fields 830a and 831a and model information fields 830b and 831b, respectively, as described in the previous exemplary embodiments. Each of the model information fields 830b and 831b may include configuration ID(s) indicating required network configurations and information on a base station-side model.

The tenth exemplary embodiment of the present disclosure described above may be applied together with the first to ninth exemplary embodiments described above. Further, the tenth exemplary embodiment of the present disclosure may be applied together with other exemplary embodiments described below to the extent that they do not conflict with each other.

### Eleventh Exemplary Embodiment

The eleventh exemplary embodiment of the present disclosure may be applied when the following conditions are satisfied.

Condition 1: An artificial neural network for wireless communication is applied in a mobile communication system consisting of a base station and a terminal.

Condition 3: The terminal may configure and/or utilize multiple artificial neural network models for multiple functions.

According to the eleventh exemplary embodiment of the present disclosure, an entity (or server or cloud) that manages artificial neural network model(s) for a terminal may deliver detailed information of the artificial neural network model(s) for each model ID and/or each vendor ID to an entity (or server or cloud) that manages artificial neural network model(s) for a base station. In addition, the terminal may transmit information on the artificial neural network model(s) supported by the terminal by reporting model ID(s) and/or vendor ID(s) of the artificial neural network model(s) it supports to the base station or network.

In this case, the base station may obtain detailed information on the artificial neural network model(s) supported by each terminal from the entity that manages artificial neural networks for the base station by using the model ID(s) and/or vendor ID(s).

In the eleventh exemplary embodiment of the present disclosure, it is assumed that the terminal supports one or more artificial neural network models for wireless communication, and that support from the base station or network is required to use the artificial neural network model of the terminal. In this case, the terminal may need to report information on the artificial neural network model(s) it possesses to the base station so that the base station recognizes the artificial neural network model(s) of the terminal. To this end, each terminal may report information on model(s) directly to the base station. However, if a terminal vendor (or provider) separately operates an entity such as an OTT server or cloud that manages artificial neural network model(s) of the terminal, the entity may deliver detailed information of the artificial neural network model(s) of the terminal to the base station or network.

In this case, a node that receives the detailed information of model(s) at the base station or network may be an entity such as an OTT server or cloud that manages artificial neural network model(s) for the base station. Thereafter, when each terminal accesses each base station, it may deliver information on the artificial neural network model(s) supported by the terminal by reporting model IDs and/or vendor IDs of the artificial neural network models it supports to the network.

The base station may obtain detailed previously-stored information on the models from the artificial neural network management server for the terminals by using the identifier information (i.e., model ID(s) and/or vendor ID(s)) reported by the terminal.

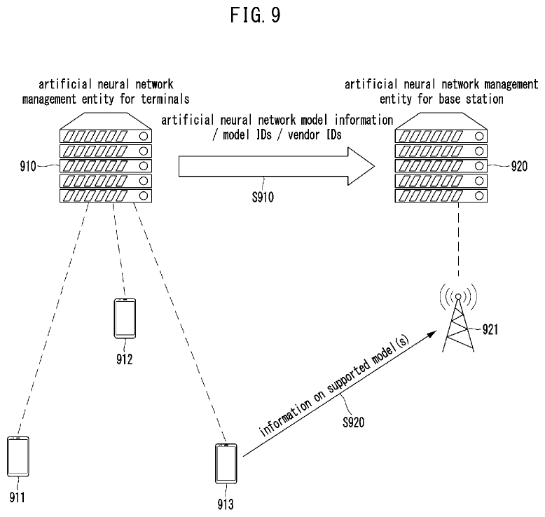

FIG. 9 is a conceptual diagram for describing artificial neural network model information registration and calling operations according to the eleventh exemplary embodiment of the present disclosure.

Referring to FIG. 9, a plurality of terminals 911, 912, and 913 may all be terminals that can use artificial neural network models. In addition, manufacturers of the terminals 911, 912, and 913 may be the same or different. The present disclosure may include an entity 910 that manages artificial neural networks for the terminals 911, 912, and 913. The artificial neural network management entity 910 for the terminals may be configured as one server or two or more servers, or may be implemented in a cloud. It may also be a separate management server for each manufacturer.

According to the eleventh exemplary embodiment of the present disclosure, an artificial neural network management entity 920 for the base station 921 may exist. The artificial neural network management entity 920 for the base station may be configured as one server or two or more servers, or may be implemented in a cloud. In addition, the artificial neural network management entity 920 for the base station may be implemented for each telecommunication service provider.

The terminals 911 to 913 may report model ID(s) and/or vendor ID(s) of artificial neural network models they support to the artificial neural network management entity 910 for the terminals. The artificial neural network management entity 910 for the terminals may receive and store them. In a step S910, the artificial neural network management entity 910 for the terminals may provide stored information, such as artificial neural network model information, model ID information, and vendor information for a specific terminal, to the artificial neural network management entity 920 for the base station.

For example, a time point when the step S910 is performed may corresponding to a time point according to a preset interval, a time point when there is a request from another device that is allowed to access, and/or a time point when there is an update of information.

The third terminal 913 may transmit information on supported model(s) to the base station 921 in a step S920. The step S920 may be performed when the third terminal 913 initially accesses the base station 921 and/or when the third terminal 913 is handed over to the base station 921. Here, information on the supported model(s) may inform the artificial neural network model ID(s) and vendor ID(s) thereof to the base station 921.

For example, if there are three artificial neural network models supported by the terminal, the artificial neural network model IDs and vendor IDs may be reported. The report message may take one of two formats below.

<Report Format 1>
(model identifier 0, vendor identifier)=(0, 0)
(model identifier 1, vendor identifier)=(1, 0)
(model identifier 4, vendor identifier)=(4, 0)

<Report Format 2>
(Model Identifier 0, Model Identifier 1, Model Identifier 4, Vendor Identifier)=(0, 1, 4, 0)

In the case of the report format 2, a model ID field and a vendor ID field may be distinct from each other.

When the base station 921 receives information on supported model(s) based on at least one of the above-described report message formats from the third terminal 913, the base station 921 may use the received information to obtain, from the artificial neural network management entity 920 for the base station, information on artificial neural network(s) for the third terminal 913.

To summarize the operation of FIG. 9 described above, the artificial neural network management entity (or server or cloud) 910 for the terminals, which manages the artificial neural network model(s) of the terminals, may receive and collect information from each of the terminals 911 to 913. The artificial neural network management entity (or server or cloud) 910 for the terminals may deliver detailed information of the artificial neural network model(s) to the artificial neural network management entity (or server or cloud) 920 for the base station. Thereafter, each terminal may report information on model(s) that it supports by using model ID(s) and vendor ID(s) when accessing the base station or network. The base station 921 may obtain information on artificial neural network(s) for each terminal from the artificial neural network management entity (or server or cloud) 920 for the base station based on the information received from each terminal.

The eleventh exemplary embodiment of the present disclosure described above may be applied together with the first to tenth exemplary embodiments described above. Further, the eleventh exemplary embodiment of the present disclosure may be applied together with other exemplary embodiments described below to the extent that they do not conflict with each other.

### Twelfth Exemplary Embodiment

The twelfth exemplary embodiment of the present disclosure may be applied when the following conditions are satisfied.

Condition 1: An artificial neural network for wireless communication is applied in a mobile communication system consisting of a base station and a terminal.

Condition 3: The terminal may configure and/or utilize multiple artificial neural network models for multiple functions.

According to the twelfth exemplary embodiment of the present disclosure, a base station may deliver information on currently-registered artificial neural network models of terminals to a terminal, and if there is an artificial neural network model that is not currently registered among models held by the terminal, the terminal may request registration of the corresponding artificial neural network model.

In this case, the base station may transmit information on the currently registered artificial neural network models through system information such as a system information block (SIB), and the information may include model ID(s) and/or vendor ID(s).

In the eleventh exemplary embodiment of the present disclosure, it is assumed that the terminal supports one or more artificial neural network models for wireless communication and can report a status of the artificial neural network model(s) it supports to the base station. In this case, a case where artificial neural network models of terminals provided by the same terminal provider overlap at least partially may occur. That is, for the same base station or network, there may occur a case where another terminal from the same terminal provider has already registered an artificial neural network model a terminal wants to use. In this case, it may be required to prevent different terminals from repeatedly registering the same artificial neural network model to avoid unnecessary waste of resources.

Therefore, in the present disclosure, the base station may transmit information on the currently-registered artificial neural network models of terminals to a terminal, and each terminal may request registration of an artificial neural network model only when the artificial neural network model is a model that is not currently registered among models held by the terminal.

According to the twelfth exemplary embodiment of the present disclosure, the base station may transmit information on the currently-registered artificial neural network models through system information such as a SIB, and the information on the model(s) may include model ID(s) and/or vendor ID(s).

The terminal may check whether its model is registered with the base station by comparing model ID(s) and/or vendor ID(s) of model(s) it owns with the model ID(s) and/or vendor ID(s) of the registered model(s) delivered from the base station.

As a result of checking the model ID(s) and/or vendor ID(s) related to the registered artificial neural network models broadcasted by the base station, if the same model ID and/or vendor ID as the artificial neural network that terminal desires to use has been already registered in the base station, the terminal may not perform required network configuration reporting or model status reporting.

On the other hand, as a result of checking the model ID(s) and/or vendor ID(s) related to the registered artificial neural network models broadcasted by the base station, if the same model ID and/or vendor ID as the artificial neural network that terminal desires to use has not been registered in the base station, the terminal may request registration of the corresponding artificial neural network model.

The twelfth exemplary embodiment of the present disclosure described above may be applied together with the first to eleventh exemplary embodiments described above to the extent that they do not conflict with each other.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a communication node, comprising:
transmitting required network configurations for applying each artificial neural network models to a network node; and
transmitting a status report of the first model including a model identifier field and a model information field for each of the artificial neural network models to the network node to activate at least one artificial neural network model among the artificial neural network models,
wherein each of the required network configurations includes a configuration identifier and network configuration information.

2. The method according to claim 1, wherein the network configuration information includes one or more Radio Resource Configuration (RRC) information elements (IEs) corresponding to a required network configuration corresponding to each of the artificial neural network models.

3. The method according to claim 1, wherein the model information field includes at least one of required network configuration information for an inference task corresponding to each of the artificial neural network models, auxiliary network configuration information for an inference task corresponding to each of the artificial neural network models, model performance indicator for each of the artificial neural network models, preference for each of the artificial neural network models, or preference priority information for each of the artificial neural network models.

4. The method according to claim 1, wherein the status report of the first model includes only a model status report corresponding to a currently supportable artificial neural network model.

5. The method according to claim 1, further comprising: transmitting a status report of the second model to the network node, wherein the second model state report is transmitted to the network node, when at least one occurs among a case when model status information of the communication node is changed, a case when the network node indicates the communication node to transmit the status report of the second model, a case when a retransmission prohibit timer for the status report of the first model expires and there is an artificial neural network model currently supported by the communication node, a case when a periodic transmission timer for the status report of the first model expires and there is an artificial neural network model currently supported by the communication node, or a case when a handover procedure occurs.

6. The method according to claim 1, further comprising:
receiving, from the network node, indication information on activation or deactivation of an artificial neural network model corresponding to an artificial neural network model not included in the status report of the first model; and
ignoring the activation or deactivation of the artificial neural network model according to the indication information.

7. The method according to claim 1, further comprising:
receiving, from the network node, an activation indication on one or more artificial neural network models in response to the status report of the first model;
activating the one or more artificial neural network models based on the activation indication;
when an artificial neural network model activated in the communication node is deactivated, generating a status report of the second model including deactivation information of the deactivated artificial neural network model; and
transmitting the status report of the second model to the network node.

8. The method according to claim 1, wherein when there is a first artificial neural network model on which the communication node and the network node need to jointly perform an inference task among the artificial neural network models, the model information field includes at least one of whether or not a network node-sided artificial neural network model exists in the network node, an identifier of the network node-sided artificial neural network model of the network node, input and output of the network node-sided artificial neural network model of the network node, execution environment information of the network node-sided artificial neural network model of the network node, or an inference latency required for an inference operation of the network node-sided artificial neural network model of the network node.

9. The method according to claim 1, further comprising: receiving, from the network node and in advance, information of a first artificial neural network model on which the communication node and the network node need to jointly perform an inference task.

10. The method according to claim 1, wherein the network node is one of a base station connected to the communication node, a server that manages the artificial neural network models, or a cloud that manages the artificial neural network models.

11. A method of a network node, comprising:
receiving required network configurations for applying each of artificial neural network models from a communication node;
receiving at least one status report of the first model including a model identifier field and a model information field for each of the artificial neural network models;
determining whether to allow each of the artificial neural network models based on the received status report of the first model and a load of the network node; and
transmitting information indicating whether or not to allow each of the artificial neural network models to the communication node,
wherein each of the required network configurations includes a configuration identifier and network configuration information.

12. The method according to claim 11, wherein the network configuration information includes one or more Radio Resource Configuration (RRC) information elements (IEs) corresponding to a required network configuration corresponding to each of the artificial neural network models.

13. The method according to claim 11, wherein the model information field includes at least one of required network configuration information for an inference task corresponding to each of the artificial neural network models, auxiliary network configuration information for an inference task corresponding to each of the artificial neural network models, model performance indicator for each of the artificial neural network models, preference for each of the artificial neural network models, or preference priority information for each of the artificial neural network models.

14. The method according to claim 13, further comprising: when deactivation of an activated artificial neural network model is required based on the model performance indicator of each of the artificial neural network models, transmitting information indicating deactivation of the activated artificial neural network model to the communication node.

15. The method according to claim 11, further comprising:
receiving a status report of the second model from the communication node; and
ignoring the received status report of the second model, when the status report of the second model indicates deactivation of an activated artificial neural network model.

16. The method according to claim 11, further comprising:
receiving a status report of the second model from the communication node; and
starting a procedure for deactivating an activated artificial neural network model based on the received status report of the second model, when the status report of the second model indicates deactivation of the activated artificial neural network model.

17. The method according to claim 11, further comprising: providing, to the communication node, information of a first artificial neural network model on which the communication node and the network node need to jointly perform an inference task.
